(19) United States
(12) Patent Application Publication
(10) Pub. No.: US 2003/0012511 A1
(43) Pub. Date: Jan. 16, 2003

(54) Blockless fiber attachment assembly for optical devices

(75) Inventors: Jack Po-oun Lin, Scottsdale, AZ (US); Annette Sonja Jerinic, Stanton, CA (US)

Correspondence Address: HOGAN & HARTSON L.L.P., 500 S. GRAND AVENUE, SUITE 1900, LOS ANGELES, CA, 90071-2611, US

(73) Assignee: Aeroflex-TriLink Corporation

(21) Appl. No.: 09/902,147

(22) Filed: Jul. 10, 2001

(51) Int. Cl. G02B 6/26

(52) U.S. Cl. 385/51; 385/49; 385/50

(57) ABSTRACT

An optical fiber attachment assembly and method of making such an assembly. The assembly includes an optical device having an optical waveguide with an end surface exposed on an end surface of the device, and a bare optical fiber having an end surface cleaved at a predetermined angle and aligned with the end surface of the waveguide. The end of the fiber is affixed to the optical device by a first adhesive. A strain relief block positioned at a distance from the end surface of the optical device and the optical fiber is affixed to the strain relief block by a second adhesive to securely mount the fiber to the optical device. The optical device and the strain relief block are mounted on a carrier. Also described is a method for attaching an optical fiber to a waveguide in an optical device. The fiber attachment assembly and method can be used in a flip-chip configuration where the chip is mounted on a ground plane in a flipped orientation via a plurality of spacers.

### BACKGROUND OF THE INVENTION

1. Field of the Invention

This invention relates to a method for attaching a bare fiber to an optical device, and to an optical fiber attachment assembly having such attached optical fibers.

2. Description of the Related Art

In forming optical devices, especially integrated optical devices having an optical waveguide formed in a substrate, structures for aligning a bare fiber to the waveguide and attaching the fiber to the substrate is often essential. In typical conventional designs in which a bare fiber is attached to an optical element, a block structure is used to hold the fiber tip and attach it to other parts of the optical device. For example, one conventional method uses two ferrule blocks to sandwich an optical fiber between the blocks. The blocks with the fiber are then diced at an angle, polished and lined up to the waveguide. Such block-encased structures make the device difficult to work with and increase the weight and bulk to the entire device. U.S. Pat. No. 6,205,280 describes a fiber optic attenuator in which the two ends of an optical fiber are held by a fiber support structure for supporting the fiber across the attenuator, the support structure having two longitudinal notches at the two end portions to accommodate the fiber, the structure further including two strain reliefs that fits around the end portions of the fiber support to hold the fiber, and two end caps to secure the reliefs on a shell piece that encloses the fiber support. The structure requires multiple structural pieces to secure each end of the fiber, which makes the entire structure rather bulky. Another example of a fiber attachment structure is described in U.S. Pat. No. 5,469,522 for an optical fiber splice interconnection. The ends of the two fibers being interconnected are each held by a crimp bushing secured to a housing that encloses the fiber alignment element. Again, the structure requires multiple structural pieces and is bulky.

### SUMMARY OF THE INVENTION

The present invention is directed to a method of attaching a bare fiber to an optical device that substantially obviates one or more of the problems due to limitations and disadvantages of the related art.

An object of the present invention is to provide a method of attaching a bare fiber to the optical device so that it is aligned with the waveguide at a desired angle, and an optical device having such an attached fiber.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides an optical fiber attachment assembly comprising an optical device having an optical waveguide formed thereon, the optical waveguide having an end surface exposed on an end surface of the device, and a bare optical fiber having an end surface cleaved at a predetermined angle, the end surface of the optical fiber being aligned with the end surface of the waveguide and affixed to the optical device by a first adhesive. The assembly may additionally comprise a strain relief block positioned at a distance from the end surface of the optical device, wherein the optical fiber is affixed to the strain relief block by a second adhesive.

In another aspect, the present invention provides a method of attaching an optical fiber having a cleaved end to an optical device having an optical waveguide formed thereon, the optical waveguide having an end surface exposed on an end surface of the device, the method comprising aligning the cleaved end of the optical fiber to the end surface of the optical waveguide, and applying a first adhesive to the end of the optical fiber to affix the fiber to the optical device. The method may additionally comprise providing a strain relief block at a distance from the end surface of the optical device and abutting the fiber, and applying a second adhesive to the optical fiber to affix it to the strain relief block.

It is to be understood that both the foregoing general description and the following detailed description are exemplary and explanatory and are intended to provide further explanation of the invention as claimed.

### BRIEF DESCRIPTION OF THE DRAWINGS

FIG. 1 illustrates an optical device having a bare fiber attached thereto according to an embodiment of the present invention.

FIGS. 2a and 2b illustrate a flip-chip optical device having a bare fiber attached thereto according to another embodiment of the present invention.

### DETAILED DESCRIPTION OF THE PREFERRED EMBODIMENTS

The present invention is an attachment method that enables a polarized, precisely angled bare fiber to be accurately orientated and attached to a waveguide of an optical device without the addition of blocks at the fiber tip. By eliminating the use of blocks, a device is created that is lightweight and easy to handle, yet it provides extremely stable optical power transfer over a wide range of humidity and temperature environments.

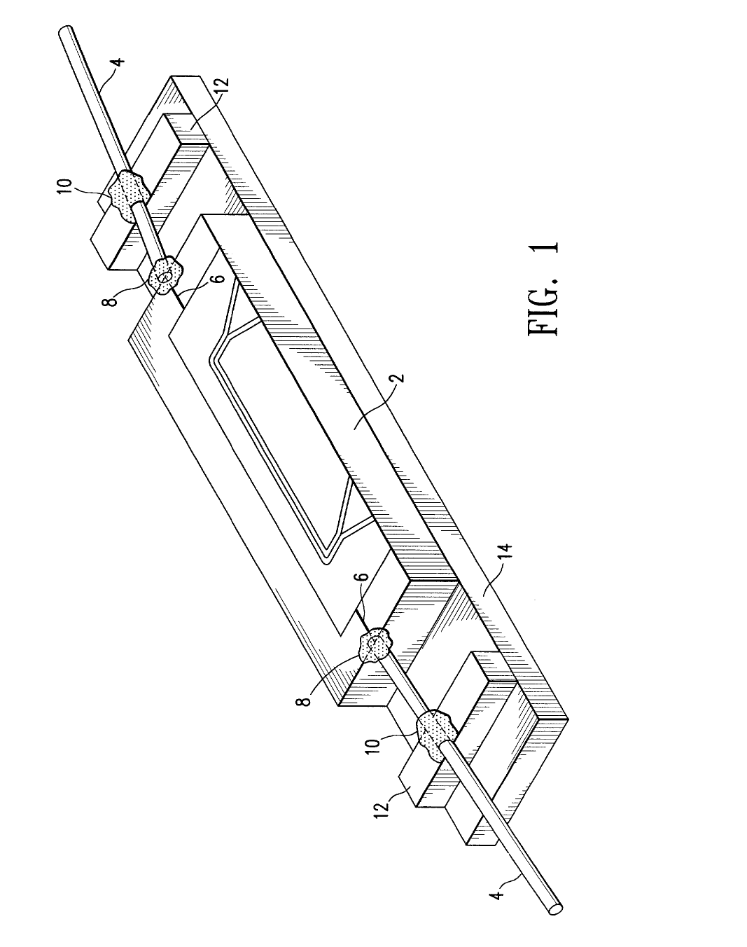

An embodiment of the invention is described with reference to FIG. 1. Reference numeral 2 denotes an optical device to which a bare fiber 4 is to be attached, including a waveguide 6 having an exposed end on a surface of the device, to which the fiber is to be aligned and coupled. The optical device 2 may be an integrated optical device, electro-optical device or other device, which has a substrate and integrated optical, electrical, electro-optic or other elements formed therein. The optical device 2 may also be a device having discrete optical and other elements. The structure of the optical device 2 is not critical to this invention, so long as it includes at least a waveguide 6, because the invention is directed to the attachment of an optical fiber to a waveguide on an optical device. In addition, the term “optical device” is used in this disclosure to refer to the device to which the fiber is attached, and may include optical, electro-optical or other types of devices. In one particular application of the present invention, the optical device is an integrated electro-optical device having a lithium niobate substrate 2 and an waveguide 6 formed therein, where the optical fiber 4 is attached to a side surface of the substrate.

The bare fiber 4, either a polarization-sensitive fiber or a non-polarization-sensitive fiber, is precisely cleaved at a predetermined angle according to the desired application using a device such as a cleaver. To accomplish this, the bare fiber is placed in the cleaver, aligned to a predetermined angle, and then cleaved by bringing down the cutting blade. The cleaved fiber is then placed in a grooved staging device to be aligned. For a polarization-sensitive fiber, the fiber is rotated to the optimum polarization to maximize optical power transfer. Optical power transfer may be measured, for example, by measuring the insertion loss, or the difference between the input and output voltages of the fiber. Once the fiber is properly oriented, the angled end of the cleaved fiber 4 is precisely oriented and aligned with the exposed end of the waveguide 6, again by maximizing the optical power transfer. The method contemplated by the inventors for adjusting polarization orientation and alignment of the fiber is by hand, although it may be possible to accomplish such operations by a machine, which will also come under the coverage of the present invention.

The aligned fiber 4 is affixed with a first adhesive 8 to the surface of the optical device 2 near the end of the waveguide 6. The first adhesive 8 is cured for a an appropriate amount of time to ensure a secure connection of the fiber 4 to the surface. Any suitable adhesive may be used as the first and second adhesives, one preferred example being epoxy. Curing can be done by any suitable method, such as by using an ultraviolet light. Care should be taken to minimize stress on the fiber and misalignment caused by direct application of the adhesive to the fiber during adhesive application and curing. Once the first adhesive is cured, a second adhesive 10 is applied and cured to affix the fiber 4 to a strain relief block 12 abutting the fiber 4 and positioned at a distance from the attached end of the fiber. Alternatively, the first and second adhesives may be applied simultaneously and cured simultaneously, although applying one adhesive at a time is more preferred because it reduces stress in the fiber. By attaching the fiber 4 with the first and second adhesives 8 and 10 to the surface of the optical device and the strain relief block, a durable and robust connection is obtained.

The strain relief block 12 is held at a fixed position with respect to the optical device 2. In the illustrated embodiment, the strain relief block 12 and the optical device 2 are mounted on the top surface of a carrier 14, with an adhesive or any other suitable mounting method. Preferably, the carrier is diced to the dimension of the optical device 2. Any other suitable mounting configuration may be adopted, such as mounting pieces attached to the side surfaces of the optical device 2 and the strain relief block 12. Alternatively, the strain relief block 12 may be formed as an integral part of the optical device 2 (not shown). In addition, a case or protective cover (not shown) may be provided to enclose the optical device 2, the strain relief block 12, and carrier (if any), with a feedthrough provided thereon for the attached fiber. The protective cover may be made of metal or other suitable materials. The feedthrough may be a simple passage; alternatively, a holding member may be provided to protect and accommodate the fiber.

The fiber attachment method according to the present invention provides a greater span of maneuverability without the bulk of conventional designs. In addition, by eliminating the need for ancillary attachment components, maximum power is obtained with minimum load (weight) on the fiber.

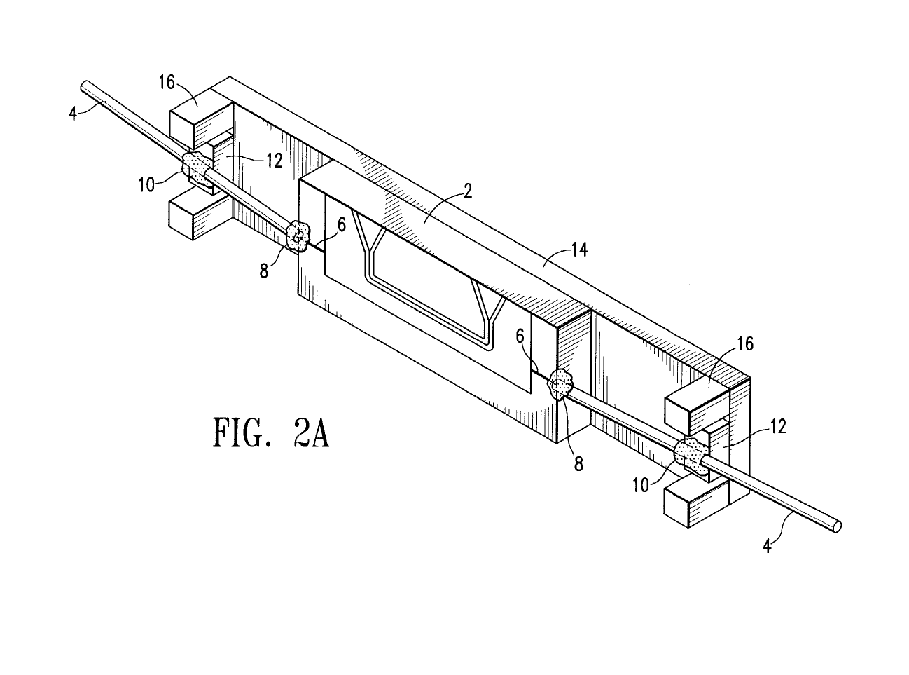

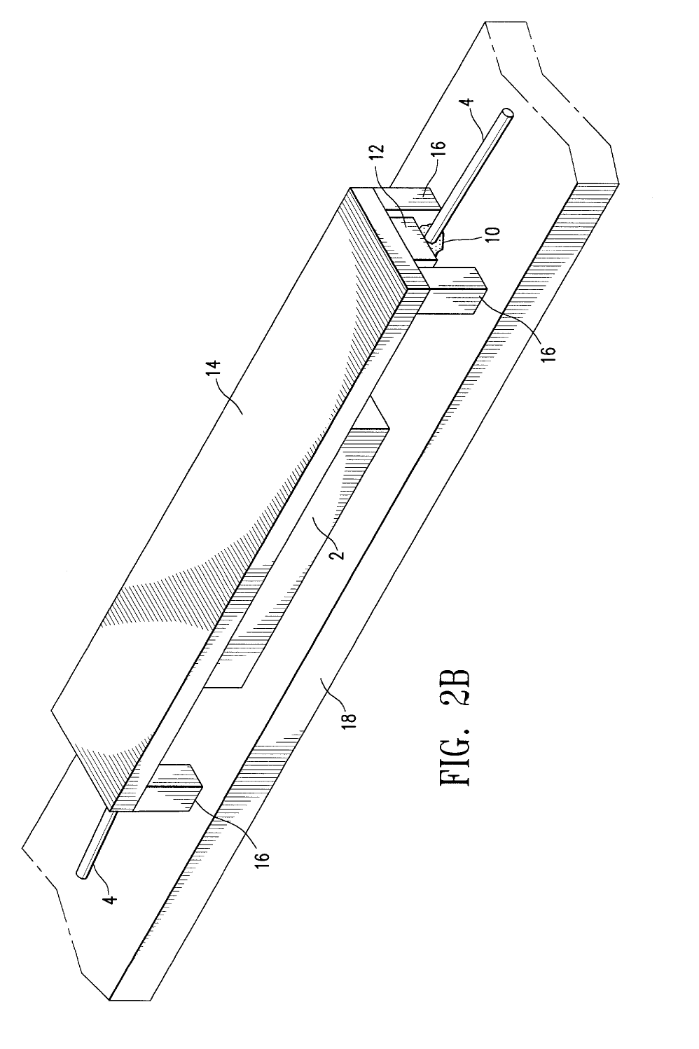

FIGS. 2a and 2b illustrate a flip chip according to another embodiment of the present invention. Similar to the embodiment of FIG. 1, the optical device 2 is mounted on a carrier 14. One or more, preferably four, spacers 16 are provided on the carrier 14 for mounting the carrier and the optical device on a ground plane 18 in a flipped (or face-down) orientation. The spacers 16 are disposed so that they allow the optical fiber to pass through to the outside. Although the spacers 16 are shown to be adjacent the strain relief block 12 in FIG. 2a, other relative spatial relationship of the spacers and the strain relief blocks can be adopted as long as the spacers can accommodate the fiber. The height of the spacers 16 are slightly larger than that of the optical device 2, so that only the spacers and not the optical device are in contact with the ground plane 18. The fiber 4 is aligned and attached to the optical device 2 in a similar manner as in the embodiment of FIG. 1. Although only one chip (optical device 2 mounted on carrier 14) is shown in FIG. 2b, a plurality of chips may be mounted on the same ground plane.

The elimination of ferrule blocks in the fiber attachment assembly is especially advantageous in a flip-chip configuration. In such a configuration, the chip is often required to face the ground plane with a small spacing in between. A fiber attachment using ferrule blocks will be incompatible with such a configuration because of the bulk of the ferrule blocks. The blockless fiber attachment according to the present invention, on the other hand, enables the bare fiber to be securely attached to the chip and to pass to the outside in the limited space provided by the spacers.

The fiber attachment structure described above can be readily expanded to provide an optical device with multiple input and output optical fibers. Each fiber may be individually cleaved, aligned and mounted as described above. As currently contemplated, the multiple fibers are mounted sequentially by hand, although it may also be possible to accomplish this using a machine and/or aligning more than one fiber simultaneously. Optical devices having multiple fibers providing multiple inputs and outputs are commonly used because a single such device can satisfy several requirements and takes up less space than multiple devices, even though such a device tends to be heavier. Typically, all fibers in a multiple fiber device are at the same level, and all fibers are required to have the same amount of protrusion and the same orientation.

In addition to lightweight and compactness in design, the blockless fiber attachment method and assembly of the present invention have many advantage over block-encased structures. For example, the angle accuracy requirement can be less stringent without sacrificing power transfer. A smaller gap between the waveguide and the fiber results in less power loss. Bare fiber is smaller and therefore easier to manipulate than blocks. It is also easy to align or realign the fiber if the orientation/polarization is off.

It will be apparent to those skilled in the art that various modifications and variations can be made in the fiber attachment method and device of the present invention without departing from the spirit or scope of the invention. Thus, it is intended that the present invention cover modifications and variations that come within the scope of the appended claims and their equivalents.

What is claimed is:

1. An optical fiber attachment assembly comprising:
an optical device having an optical waveguide formed thereon, the optical waveguide having an end surface exposed on an end surface of the device; and
a bare optical fiber having an end surface cleaved at a predetermined angle, the end surface of the optical fiber being aligned with the end surface of the waveguide, the optical fiber being affixed to the optical device by a first adhesive.

2. The optical fiber attachment assembly of claim 1, further comprising a strain relief block positioned at a distance from the end surface of the optical device, wherein the optical fiber is affixed to the strain relief block by a second adhesive.

3. The optical fiber attachment assembly of claim 2, further comprising a carrier, wherein the optical device and the strain relief block are mounted on a surface of the carrier.

4. The optical fiber attachment assembly of claim 3, wherein the strain relief block is formed integrally with the optical device or the carrier.

5. The optical fiber attachment assembly of claim 1, wherein the optical fiber is a polarized bare fiber and the end surface of the fiber is oriented with respect to the end surface of the waveguide.

6. The optical fiber attachment assembly of claim 1, wherein the optical device comprises a lithium niobate substrate and the optical waveguide is integrated therein.

7. The optical fiber attachment assembly of claim 6, further comprising a carrier, wherein the substrate is mounted on a top surface of the carrier with a third adhesive, and wherein the carrier and the substrate have identical widths.

8. The optical fiber attachment assembly of claim 1, further comprising:
a carrier having a surface on which the optical device is mounted;
a strain relief block mounted on the surface of the carrier and positioned at a distance from the end surface of the optical device, wherein the optical fiber is affixed to the strain relief block by a second adhesive;
a plurality of spacers; and
a ground plane, wherein the carrier is mounted on the ground plane via the spacers, and wherein the optical device is disposed between the carrier and the ground plane in a space defined by the spacers.

9. A method of attaching an optical fiber having a cleaved end to an optical device having an optical waveguide formed thereon, the optical waveguide having an end surface exposed on a end surface of the device, the method comprising:
aligning the cleaved end of the optical fiber to the end surface of the optical waveguide; and
applying a first adhesive to the end of the optical fiber to affix the fiber to the optical device.

10. The method of claim 9, further comprising:
providing a strain relief block at a distance from the end surface of the optical device and abutting the fiber; and
applying a second adhesive to the optical fiber to affix it to the strain relief block.

11. The method of claim 10, further comprising:
curing the first adhesive after it is applied before applying the second adhesive.

12. The of claim 10, wherein the first and second adhesives are applied simultaneously, the method further comprising curing the first and second adhesives simultaneously.

13. The method of claim 10, wherein the first and second adhesive are epoxy, the method further comprising curing the first and second adhesive with an ultraviolet light.
